(19) United States
(12) Patent Application Publication
(10) Pub. No.: US 2024/0080953 A1
(43) Pub. Date: Mar. 7, 2024

(54) A CONTROL SYSTEM FOR CONTROLLING A PLURALITY OF LIGHTING UNITS AND A METHOD THEREOF

(71) Applicant: SIGNIFY HOLDING B.V., EINDHOVEN (NL)

(72) Inventors: PAUL ULCO BROEKMAN, EINDHOVEN (NL); BARTEL MARINUS VAN DE SLUIS, EINDHOVEN (NL); BERENT WILLEM MEERBEEK, VELDHOVEN (NL); SIMONE MARIA STAVENUITER, GELDROP (NL); PAUL THURSFIELD, EINDHOVEN (NL)

(21) Appl. No.: 17/767,625

(22) PCT Filed: Oct. 5, 2020
(86) PCT No.: PCT/EP2020/077854

§ 371 Date: Apr. 8, 2022

(30) Foreign Application Priority Data
Oct. 11, 2019 (EP) 19202716.7

(51) Int. Cl. H05B 45/20; H05B 47/155; H05B 47/19

(52) U.S. Cl. CPC H05B 45/20; H05B 47/155; H05B 47/19

(57) ABSTRACT

A method and a control system 100 for controlling a plurality of lighting units 112, 114 are disclosed. The control system 100 comprises a communication unit 104 configured to communicate with the plurality of lighting units 112, 114, a user interface 102 configured to receive a first user input indicative of a selection of one or more colors for the plurality of lighting units 112, 114, a processor 106 configured to control the plurality of lighting units 112, 114 via the communication unit 104 according to the selected one or more colors, wherein the user interface 102 is configured to receive a second user input indicative of a selection of a value within a range of values, and wherein the processor 106 is configured to obtain a color palette associated with the selected one or more colors, to determine a color spread of colors of the color palette as a function of the value within the range of values, and to control the plurality of lighting units 112, 114 via the communication unit 104 according to a plurality of colors of the color spread.

### FIELD OF THE INVENTION

The invention relates to a control system for controlling a plurality of lighting units. The invention further relates to a method of controlling a plurality of lighting units, and to a computer program product for executing the method.

### BACKGROUND

Smart lighting systems enable users to control lighting units in an environment, such as the user's home. Such smart lighting systems may comprise multiple lighting units and lighting control devices connected to the lighting units. Examples of control devices are smartphones, voice assistants, (rotary) switches, etc. The light output of the lighting units is controlled based on user inputs received via these control devices. A user may, for example, select a color for each lighting unit (e.g. red) by actuating a light switch, and subsequently change the intensity of the light output by rotating a rotary dimmer switch. If a user would want to control multiple lighting units according to different light settings, the user would have to select colors for the lighting units individually.

US 2018/0124895 A1 discloses a controllable dynamic lighting system including a lighting element device with a set of controllable zones and a controlling means, and a method for controlling a lighting system including: receiving lighting system operation inputs, determining operation instructions for one more controllable zones based on the operation inputs, and controlling controllable zone operation based on the respective operation instructions.

An alternative way of lighting control is image-based lighting control wherein a user may select an image. Colors are extracted from the image, whereupon multiple lighting units are controlled based on the extracted colors. This may, however, result in a light scene that does not provide the desired effect (the extracted colors may for example not be the colors desired by the user).

### SUMMARY OF THE INVENTION

The inventors have realized that existing techniques for creating a light scene with multiple colors can be complex, and that using more advanced techniques may result in undesired light scenes. It is therefore an object of the present invention to provide a user-friendly way of creating colored light scenes.

According to a first aspect of the present invention, the object is achieved by a control system for controlling a plurality of lighting units, the control system comprising:
a communication unit configured to communicate with the plurality of lighting units,
a user interface configured to receive a first user input indicative of a selection of one or more colors for the plurality of lighting units,
a processor configured to control the plurality of lighting units via the communication unit according to the selected one or more colors,
   wherein the user interface is configured to receive a second user input indicative of a selection of a value within a range of values, and
   wherein the processor is configured to obtain a color palette associated with the selected one or more colors, to determine a color spread of colors of the color palette as a function of the value within the range of values, and to control the plurality of lighting units via the communication unit according to a plurality of colors of the color spread.

The user may first select one or more colors for the plurality of lighting devices by providing a (single) first input. The user interface may be configured to receive subsequent first user inputs, such that each time the user provides the first user input, one or more different colors are selected for the plurality of lighting units. This enables the user to ‘cycle’ through different colors/light scenes for the plurality of lighting units. The selected color may, for example, be blue. A color palette is obtained, which palette is based on the one or more colors selected by the first user input. The color palette may, for example, comprise different shades of green, blue and purple. The user may then provide the second user input, which is indicative of a value (e.g. a percentage) within a range of values (e.g. 0-100%). The second input may, for example, be received via a rotary switch, a slider switch, a slider on a touch screen, etc., and the extent of the second user input may determine the value within the range (e.g. the rotation angle of a rotary switch, the position of a physical or virtual slider, the duration that a button is held, etc.). Then, a color spread of colors of the color palette is determined based on the value within the range of values. The spread of colors of the color palette may be defined by a level of variation of colors, or as a level of differences between colors of the color palette. In other words, differences between colors of a wider spread of colors may be larger than differences between colors of a narrower spread. The plurality of lighting units is then controlled based on colors of the color spread. This enables a user to select a color (by providing the first user input), and subsequently determine a variation of the selected color across the plurality of lighting units (by providing the second user input, for example by rotating a rotary switch). This is beneficial, because it provides a user-friendly way of creating colored light scenes for the plurality of lighting units.

The processor may be further configured to obtain location information of the plurality of lighting units indicative of locations of the plurality of lighting units relative to each other or relative to a user location, and the processor may be further configured to map the plurality of colors onto the plurality of lighting units based on the relative locations of the plurality of lighting units. The processor may, for example, control the lighting units such that neighboring lighting units are controlled according to complementary colors, such that the neighboring lighting units are controlled according to similar colors, etc. This may be beneficial, because it may improve the light scene for the user.

The processor may be further configured to obtain information indicative of light rendering capabilities of the plurality of lighting units and/or indicative of types of the plurality of lighting units, and the processor may be further configured to map the plurality of colors onto the plurality of lighting units based on the light rendering capabilities and/or the types of the plurality of lighting units.

The user interface may comprise a first user input element for receiving the first user input, and the user interface may comprise a second user input element for receiving the second user input. The first and second user input elements may be comprised in the same lighting control device (e.g. a rotary switch, a mobile device, etc.).

The second user input element may be a rotary element of a rotary switch, and the second user input may be a rotary movement of the rotary element. This enables a user to control the color spread (variation) in an intuitive way.

The first user input element may be a button, and the first user input may be an actuation of the button. The button may, for example, be a touch or press button of a light switch. Other examples of the first input element include but are not limited to a touch-sensitive display, a microphone for detecting a voice input, a gesture sensor, a presence sensor, a light switch, etc.

Alternatively, the user interface may comprise a single user input element for receiving the first and the second user input. The user interface may comprise, for example, a touch-sensitive display for receiving the first and second user inputs.

The second user input may be a directional user input, and the processor may be configured to increase the color spread when the second user input is provided in a first direction, and the processor may be configured to decrease the color spread when the second user input is provided in a second direction. A user may, for example, rotate a rotary switch in a first direction (e.g. clockwise) to increase the color spread, and rotate the rotary switch in a second direction (e.g. counterclockwise) to decrease the color spread. A user may, for example, slide a (virtual or physical) slider in a first direction (e.g. rightward) to increase the color spread, and slide the slider in a second direction (e.g. leftward) to decrease the color spread. This enables a user to control the color spread (variation) in an intuitive way.

The second user input may be received during a period of time, and the processor may be configured to increase the color spread as a function of a duration of the second user input. This enables a user to control the color spread by, for example, providing a single input (e.g. by pressing and holding a button).

The processor may be configured to select colors from the plurality of colors of the color spread such that a difference between a first color and a second color is maximized. In the context of the present application, the term “difference between colors” relates to a level of difference between two or more colors. The difference may, for example, be expressed as a difference in color values. The difference may, for example, be expressed as a distance between colors in a color diagram (e.g. in the CIE color space or any other color space). The difference may, for example, be expressed as a difference in wavelength of the light (e.g. the difference between blue and green may be smaller than the difference between blue and orange).

The first user input may be indicative of a selection of an image comprising the one or more colors for the plurality of lighting units, and the processor may be configured to obtain the color palette based on colors of the image. This enables a user to select an image, and to control the color spread of colors of the image by providing the second user input, which provides a user-friendly way of creating a colored light scene for the plurality of lighting units.

The processor may be further configured to obtain information indicative of one or more of: an activity of a user, a mood of a user and an active atmosphere, and the processor may be further configured to determine the color spread further based on the activity and/or the mood of the user. For certain activities (e.g. reading, watching a drama movie, dinner, etc.), a narrower spread may be desirable, whereas for other activities (e.g. a party, watching an action movie, etc.) a broader spread may be desirable. Additionally or alternatively, the processor may be further configured to determine the color palette based on the activity and/or the mood of the user.

The processor may be further configured to determine the color spread based on a color matching rule, wherein the plurality of colors of the color spread match the one or more colors according to the color matching rule. The color matching rule may indicate that the colors should be complementary, split-complementary, analogous, triadic, double complementary, etc. The processor may be further configured to determine a color matching rule based on properties of the lighting units (e.g. a number of lighting units, types of the lighting units, light rendering capabilities of the lighting units, etc.). Determining the colors of the color spread such that they match the one or more colors (selected by the first user input) according to the color matching rule is beneficial, because the colors create a consistent light scene. The color matching rule may be selectable by a user, for example via the user interface. Alternatively, the color matching rule may be determined based on an external input (e.g. a lighting control routine, a mood/activity of the user, etc.).

The communication unit, the user interface and the processor may be comprised in a lighting control device. The lighting control device may, for example, be a light switch or a mobile device such as a smartphone, a tablet pc, a pair of smart glasses, a smart watch, etc.

According to a second aspect of the present invention, the object is achieved by a method of controlling a plurality of lighting units, the method comprising:
receiving a first user input indicative of a selection of one or more colors for the plurality of lighting units,
controlling the plurality of lighting units according to the selected one or more colors,
receiving a second user input indicative of a selection of a value within a range of values,
obtaining a color palette associated with the selected one or more colors,
determining a color spread of colors of the color palette as a function of the value within the range of values, and
controlling the plurality of lighting units via the communication unit according to a plurality of colors of the color spread.

According to a third aspect of the present invention, the object is achieved by a computer program product for a computing device, the computer program product comprising computer program code to perform the method when the computer program product is run on a processing unit of the computing device.

It should be understood that the computer program product and the method may have similar and/or identical embodiments and advantages as the above-mentioned control system.

### BRIEF DESCRIPTION OF THE DRAWINGS

The above, as well as additional objects, features and advantages of the disclosed systems, devices and methods will be better understood through the following illustrative and non-limiting detailed description of embodiments of devices and methods, with reference to the appended drawings, in which:

FIG. 1 shows schematically an example of a control system for controlling a plurality of lighting units;

FIGS. 2a and 2b show schematically an example of controlling a plurality of lighting units based on two user inputs received via a rotary switch;

FIGS. 3a and 3b show schematically an example of controlling a plurality of lighting units based on two user inputs received via a touch-sensitive display;

FIG. 4a shows schematically a room comprising 5 lighting units;

FIG. 4b shows schematically user interface for providing locations of the 5 lighting units relative to the room of FIG. 4b;

FIGS. 5a and 5b show schematically a selection of a color spread from a color palette based on first and second user inputs; and

FIG. 6 shows schematically a method of controlling a plurality of lighting units.

All the figures are schematic, not necessarily to scale, and generally only show parts which are necessary in order to elucidate the invention, wherein other parts may be omitted or merely suggested.

### DETAILED DESCRIPTION OF EMBODIMENTS

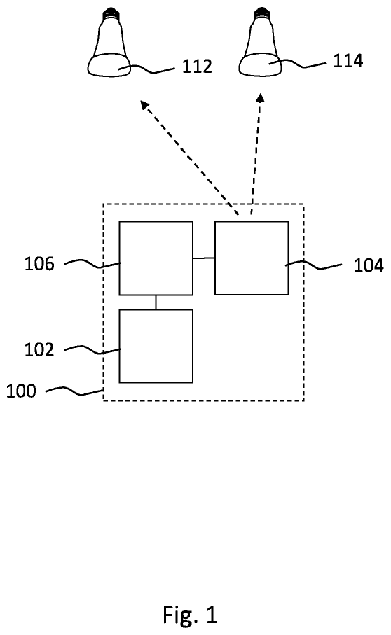

FIG. 1 shows a control system 100 for controlling a plurality of lighting units 112, 114. The control system 100 comprises a communication unit 104 configured to communicate with the plurality of lighting units 112, 114. The control system 100 further comprises a user interface 102 configured to receive a first user input indicative of a selection of one or more colors for the plurality of lighting units. The control system 100 further comprises a processor 106 (e.g. circuitry, a microprocessor, etc.) configured to control the plurality of lighting units 112, 114 via the communication unit 104 according to the selected one or more colors. The user interface 102 is further configured to receive a second user input indicative of a selection of a value within a range of values, and the processor 106 is configured to obtain a color palette associated with the selected one or more colors, and to determine a color spread of colors of the color palette as a function of the value within the range of values. The processor 106 is further configured to control the plurality of lighting units 112, 114 via the communication unit 104 according to a plurality of colors of the color spread.

The processor 106 is configured to control the plurality of lighting units via the communication unit 104. The communication unit 104 is configured to communicate with the plurality of lighting units 112, 114. The communication unit 104 may communicate lighting control commands via any wired or wireless communication protocol (e.g. Ethernet, DALI, Bluetooth, Wi-Fi, Li-Fi, Thread, ZigBee, 4G, 5G, etc.). The lighting units 112, 114 may comprise a control unit, such as a microcontroller (not shown), for controlling the light output generated by the lighting units based on received lighting control commands. A lighting control command may comprise lighting control instructions for controlling the light output, such as the color, intensity, saturation, beam size, beam shape, etc. The communication unit 104 may communicate with the lighting units 112, 114 directly or indirectly, for example via an intermediary device (such as a bridge) and/or via a network (e.g. the internet).

The user interface 102 is configured to receive a first user input indicative of a selection of one or more colors, and to receive a second user input indicative of a selection of a value within a range of values. The user interface 102 may comprise one or more user input elements for receiving the user inputs. The user interface 102 may comprise multiple devices, for example a first device for receiving the first user input and a second device for receiving the second user input.

The user may select one or more colors for the lighting units 112, 114 by providing the first user input. The user may, for example, select a light scene (e.g. a light scene comprising a first light setting for a first lighting unit 112 and a second light setting for a second lighting unit 114) by providing the first user input. The user may provide multiple (sequential) first user inputs in order to select a color (e.g. blue, yellow, white) or a light scene (e.g. a sunset scene, a rainbow scene, etc.) for the plurality of lighting units 112. The first user input may, for example, be received via a light switch (e.g. by pressing a button), via a smartphone (e.g. by selecting a color via a touch-sensitive display), via a voice assistant (e.g. by providing a voice command), by actuating a presence sensor that triggers a certain light scene for the plurality of lighting units 112, 114, etc. The first user input may be a selection of an image, and the processor 106 may be configured to control the plurality of lighting units 112, 114 based on colors of the image. The processor 106 may extract the colors of the image, or the colors may be associated and stored with the image (e.g. as metadata).

The selection of the one or more colors by providing the first user input may be limited to a subset of colors with a certain hue, saturation and/or intensity. The subset may be based on an active atmosphere, which may for example have been selected by a user, or which may have been activated based on another input (e.g. an actuation a sensor, a detected user mood/activity, a lighting control routine, etc.). Thus, the user may only select the one or more colors from the subset (e.g. a limited range of the spectrum, or a limited range of a color circle) as a first user input.

The user may then provide the second user input to change the color variation (i.e. the color spread) of the one or more colors of the plurality of lighting units 112, 114. By providing the second user input, the color spread (e.g. the amount of different colors or the level of difference between the colors) may be increased or decreased. If, for example, the plurality of lighting units 112, 114 are controlled according to a single color (or similar colors), the color spread may be increased by providing the second user input. If, for example, the plurality of lighting units 112, 114 are controlled according to multiple colors, the color spread may be decreased by providing the second user input. The processor 106 may be further configured to increase or decrease the color spread based on a current color spread of the colors of the lighting units 112, 114 (the current color spread being the color spread of the current light settings of the plurality of lighting units 112, 114).

The second user input is indicative of a selection of a value within a range of values. The second user input may, for example, be received via a light switch (e.g. by pressing and holding a button), via a smartphone (e.g. by sliding a slider via a touch-sensitive display), via a slider switch, via a rotary switch, etc. The value is then used by the processor 106 to determine the color spread. The value may be, for example, a percentage (e.g. 50%) within a range (e.g. from 0-100%), an angle (e.g. a 45-degree angle) within a range (e.g. 0-360 degrees) of a rotary switch, a duration (e.g. 2 seconds) within a range (e.g. 0-5 seconds) that a button is held, etc.

The second user input may be a directional user input, and the processor 106 may be configured to increase the color spread when the second user input is provided in a first direction, and the processor 106 may be configured to decrease the color spread when the second user input is provided in a second direction. A user may, for example, rotate a rotary switch in a first direction (e.g. clockwise) to increase the color spread, and rotate the rotary switch in a second direction (e.g. counterclockwise) to decrease the color spread. A user may, for example, slide a (virtual or physical) slider in a first direction (e.g. rightward) to increase the color spread, and slide the slider in a second direction (e.g. leftward) to decrease the color spread.

The second user input may be received during a period of time, and the processor 106 may be configured to increase the color spread as a function of a duration of the second user input. The second (temporal) user input may for example be provided by actuating a user input element for a period of time (e.g. by pressing and holding a (physical or virtual) button). The user input element may be the same user input element for receiving the first user input, or it may be a different user input element. The user may, for example, press and release a button to select the one or more colors (i.e. the first user input) and then press and hold the button to change the color spread (i.e. the second user input). The user may actuate the user input element for a period of time (e.g. a few seconds) to increase the color spread, and thereby the color variation of the light emitted by the plurality of lighting units. When the maximum color spread is reached, the color spread may be reduced if the user keeps actuating the user input element.

The processor 106 is configured to obtain a color palette associated with the one or more colors selected based on the first user input. The color palette is a set of colors associated with the one or more colors.

The color palette may, for example, be predefined. The color palette may be stored in a memory and the processor 106 may be configured to access the memory and retrieve the color palette associated with the one or more colors. The memory may be located locally (e.g. in the same device as the processor 106) or remotely and be accessible by the processor 106 via a network.

Alternatively, the processor 106 may be configured to determine/generate the color palette based on the one or more colors. The one or more colors may, for example, be colors selected from an image selected by a user by providing the first user input. The one or more colors may be part of a color palette of that image, which color palette may be determined based on color values of the image.

The processor 106 may be configured to determine/generate the color palette based on a color matching rule. The color matching rule may indicate that the colors of the palette should be complementary, split-complementary, analogous, triadic, double complementary, etc. If, for example, the plurality of lighting units 112, 114 are set to emit orange light, the processor 106 may determine a color palette for that color (e.g. analogous colors such as yellow and orange, or split complementary colors such as violet and blue). Additionally or alternatively, the processor 106 may determine the color spread defined by the second user input (i.e. the color variation according to which the lighting units 112, 114 are to be controlled) based on a color matching rule. If, for example, the color palette comprises the twelve primary, secondary and tertiary colors, the processor 106 may determine the color spread based on a color matching rule, for example analogous colors of the one or more colors, or split complementary colors.

A color matching rule indicator may be provided via a user interface (e.g. rendered on a display) to indicate to a user which color matching rule is active. The processor 106 may, for example, control the user interface such that it provides a text (e.g. displayed or spoken) illustrating the color matching rule. The text may be descriptive of the color matching rule (e.g. complementary, split-complementary, analogous, triadic, double complementary, etc.) or the text may be an abstract description of the color matching rule (e.g. “happy”, “energized”, “romantic”, etc.). Alternatively, the color matching rule may not be communicated to the user. The color matching rule may for example not be visible to a user.

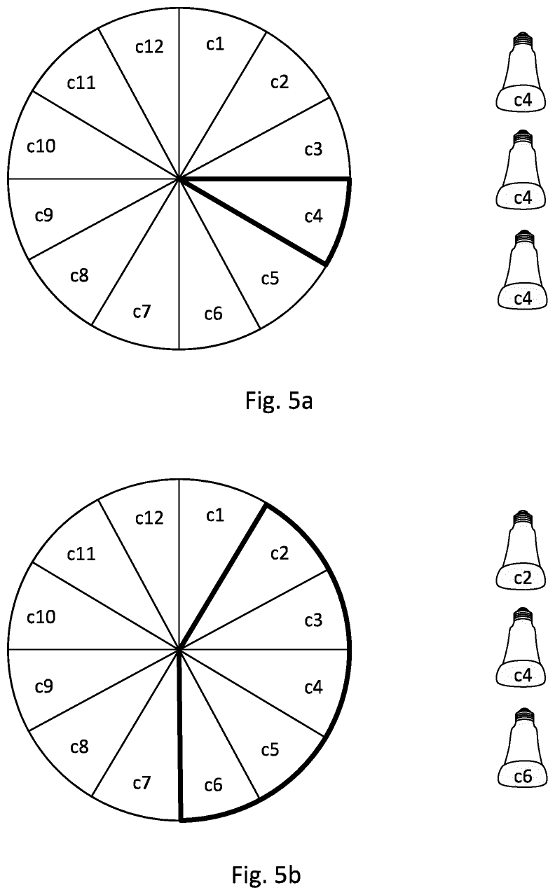

The processor 106 is configured to determine a color spread of colors of the color palette as a function of the value within the range of values (as defined by the second user input). FIGS. 5a and 5b schematically show an example of determining a color spread based on a value within a range of values. FIGS. 5a and 5b show two color circles representing color palettes comprising, for example, the primary, secondary and tertiary colors. A user may provide the first user input to select a color for the three lighting units of FIG. 5a, for example color c4. The user may then provide the second user input (e.g. by sliding a slider, by rotating a rotary switch, etc.), which is indicative of a value within a range of values, whereupon a color spread in the palette is determined by the processor 106. In this example, the color spread comprises colors c2-c6. The processor 106 may then determine how to control the lighting units based on the color spread c2-c6. The processor 106 may, for example, be configured to select colors from the plurality of colors of the color spread such that a difference at least between a first color (c2) and a second color (c6) is maximized. The processor 106 may then control the three lighting units according to colors c2, c4 and c6. If, for example, the second user input would be indicative of a greater value within the range of values, the color spread would be larger (e.g. ranging from c12 to c7). This enables a user to select a color spread (and therewith a color variety) for the lighting units of the lighting system. In this example, the color selected by the first user input is a single color c4, and the spread is increased by providing the second user input. It should be understood that the processor 106 may also perform the opposite. The first user input may be indicative of a selection of multiple colors (e.g. colors c2, c4 and c6, as illustrated in FIG. 5b), and by providing the second user input the user may decrease the spread, for example to c3-c5, resulting in that the processor 106 controls the three lighting units according to colors c3, c4 and c5, or even further, for example to c4 only, resulting in that the processor 106 controls the lighting units according to color c4 (as illustrated in FIG. 5a).

The communication unit 104, the user interface 102 and the processor 106 may be comprised in a lighting control device (e.g. a light switch or a mobile device such as a smartphone). Alternatively, the processor 106 and the communication unit 104 may be comprised in a first device (e.g. a central lighting control system, a bridge, etc.) and the user interface may be comprised in a second device (e.g. a lighting control device such as a light switch or a smartphone). The second device may further comprise a second communication unit for communicating data indicative of the first and second user input to the first device, whereupon the processor 106 may control the lighting units 112, 114 accordingly. The location of the components of the control system 100 may depend on the system architecture of the lighting system.

The lighting units 112, 114 of the lighting system are configured to receive (wireless) signals (e.g. messages comprising lighting control commands) from the control system 100. The lighting units 112, 114 may be individual LED lighting devices, individually addressable light sources of an LED strip or a light tile or a pendant light fixture, multiple lighting tiles, etc. The lighting units 112, 114 may comprise a control unit, such as a microcontroller (not shown), for controlling the light output generated by the lighting units based on received lighting control commands. The lighting control commands may comprise lighting control instructions for controlling the light output, such as the color, intensity, saturation, beam size, beam shape, etc. of the lighting units.

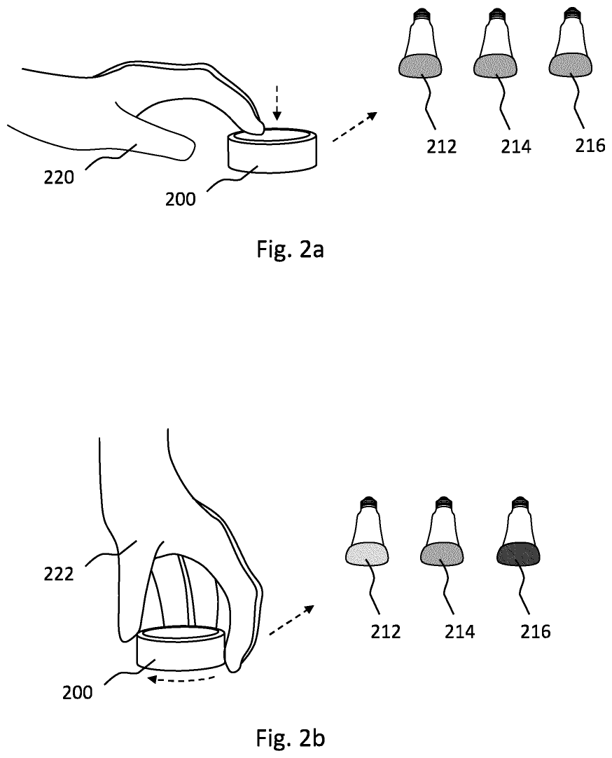

FIGS. 2a and 2b illustrate an example of a lighting control device 200. The lighting control device 200 is a rotary light switch comprising a button (e.g. a touch-sensitive button or a push button) configured to receive a first user input 220. The user may select a light scene for a plurality of lighting units 212, 214, 216 by actuating the button. The rotary light switch further comprises a rotary element configured to receive a second (rotary) user input 222. The user may select a color spread for the plurality of lighting units 212, 214, 216 by rotating the rotary switch, for example a rotation in a first direction (clockwise) to increase and a rotation in a second direction (counterclockwise) to decrease the color spread. Use of such a rotary light switch is intuitive for a user, because it enables a user to (first) select a light scene by pressing/touching rotary switch, and subsequently rotate the rotary switch to determine the color spread.

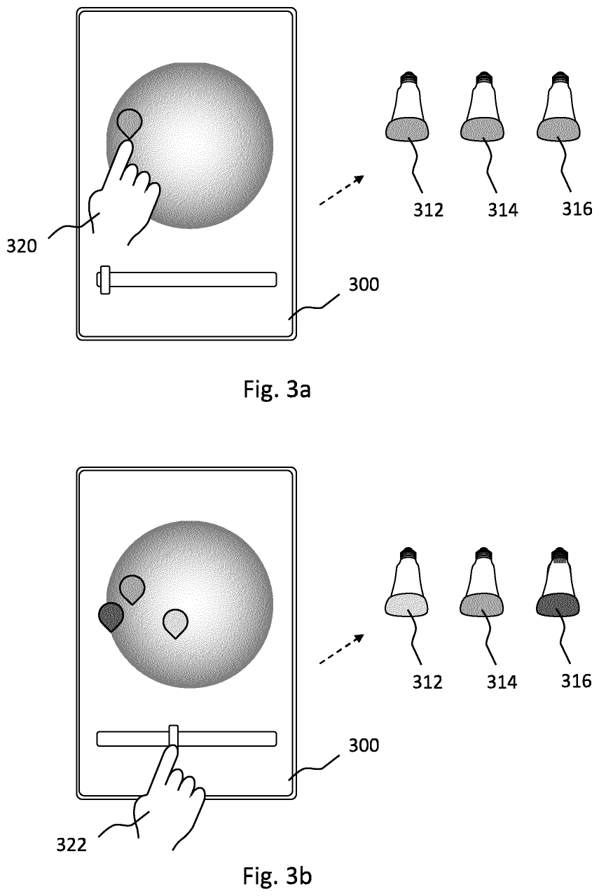

FIGS. 3a and 3b illustrate an example of a lighting control device 300. The lighting control device 300 is a portable device (e.g. a smartphone, a tablet pc, a smartwatch) comprising a touch-sensitive display configured to receive a first user input 320. The user may select a light scene for a plurality of lighting units 312, 314, 316 by selecting a color from, for example, a color circle. The touch-sensitive display is further configured to receive a second user input 322. The user may select a color spread for the plurality of lighting units 312, 314, 316 by dragging a slider, for example in a first direction (rightward) to increase and in a second direction (leftward) to decrease the color spread. The processor 106 may be further configured to render one or more icons on the touch-sensitive display to indicate the current colors of the lighting units 312, 314, 316 (as shown in FIG. 3b).

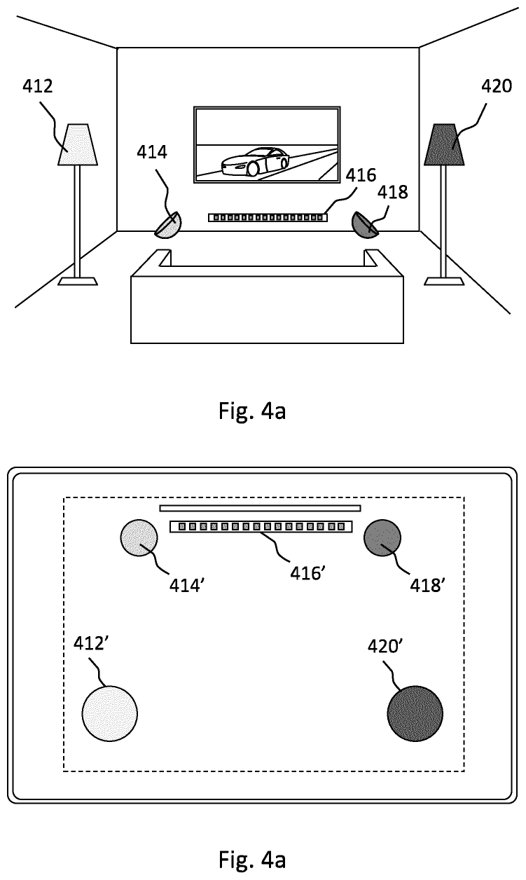

The processor 106 may be further configured to obtain location information of the plurality of lighting units 112, 114 indicative of locations of the plurality of lighting units relative to each other and/or a user location. The location information may, for example, be received from an indoor positioning system. The location information may be determined based on signals communicated between the lighting units 112, 114 (e.g. based on the RSSI of signals communicated between the lighting units). Alternatively, the locations of the plurality of lighting units may be predefined, for example when the plurality of lighting units are located at fixed locations in a luminaire (e.g. in a chandelier, in an LED strip, etc.). Alternatively, the locations of the lighting units relative to each other may be provided by a user, for example via a user interface of a central lighting control device (see FIG. 4b). The location of the user may be determined based on signals received from an (indoor) positioning system, based on the RSSI of signals communicated between the lighting units and a mobile device carried by the user, based on detected changes in the RF spectrum, based on one or more feeds from a camera system, etc. Techniques to obtain/determine/set locations of lighting units and/or a location of a user are known in the art and will therefore not be discussed in detail. The processor 106 may be further configured to map the plurality of colors (of the color spread) onto the plurality of lighting units 112, 114 based on the relative locations of the plurality of lighting units 112, 114. The processor may, for example, order the colors (e.g. based on distances between the colors in a color diagram (e.g. in the CIE color space or any other color space), based on color values, etc.), and map the colors according to the order. Additionally or alternatively, the processor 106 may group similar colors and map a group on a subgroup of lighting units that are located in each other's proximity. Additionally or alternatively, the processor 106 may be configured to map the plurality of colors (of the color spread) onto the plurality of lighting units 112, 114 based on the relative locations of the plurality of lighting units 112, 114 and based on direction (orientation) of the lighting units 112, 114.

FIG. 4a illustrates an example of a system comprising lighting units 412, 414, 416, 418 and 420. The processor 106 of the system may be configured to obtain location information indicative of the locations of the lighting units 412, 414, 416, 418 and 420 relative to each other, and to map colors of the color spread onto the lighting units 412, 414, 416, 418, 420 based on the relative locations. In the example of FIG. 4a, the color spread may, for example, be Hex Code colors #FF640D, #E83A0C, #FF1000, #E80C47 and #FF0DC8, and the processor 106 may map these colors in this order from left to right (i.e. onto lighting units 412, 414, 416, 418, 420 respectively) in order to create an analogous color gradient across the lighting units 412, 414, 416, 418, 420. The processor 106 may be configured to determine mapping based on a color matching rule. When, for example, a complementary color matching rule has been set, the processor 106 may, for example, control the lighting units 412, 414, 416, 418, 420 such that colors of neighboring lighting units are complementary, or such that colors of opposing lighting units are complementary.

FIG. 4b illustrates a user interface comprising a display for rendering icons 412′, 414′, 416′, 418′, 420′ representing the locations of the respective lighting units 412, 414, 416, 418, 420 of FIG. 4a. This user interface may be operated by a user to indicate the locations of the lighting units 412, 414, 416, 418, 420 relative to each other.

The processor 106 may be further configured to obtain information indicative of light rendering capabilities of the plurality of lighting units 112, 114 and/or indicative of types of the plurality of lighting units 112, 114. The processor 106 may be further configured to map the plurality of colors onto the plurality of lighting units based on the light rendering capabilities and/or the types of the plurality of lighting units. Some lighting units may have light rendering capabilities (e.g. the capability to render certain colors) and/or be of a type (e.g. an LED strip, a wall washer, a spotlight, etc.) more suitable for rendering certain colors. It may therefore be beneficial to map the colors onto lighting devices based on their light rendering capabilities and/or type. The processor 106 may be further configured to adjust the color for a lighting unit based on the light rendering capabilities of that the lighting unit. If, for example, a lighting unit is unable to render a certain color, the processor 106 may adjust that color such that it can be rendered by the lighting unit.

The processor 106 may be further configured to select colors from the color spread of the color palette based on the number of lighting units 112, 114. If the number of colors in the color spread is higher than the number of lighting units 112, 114, the processor 106 may select a subset of colors from the color spread of the color palette based on the number of lighting units 112, 114. Alternatively, the processor 106 may be configured to determine a maximum number of colors for the color spread based on the number of lighting units 112, 114.

The second user input may be a directional user input, and the processor 106 may be configured to increase the color spread when the second user input is provided in a first direction, and the processor 106 may be configured to decrease the color spread when the second user input is provided in a second direction. A user may, for example, rotate a rotary switch 200 in a first direction (e.g. clockwise) to increase the color spread, and rotate the rotary switch 200 in a second direction (e.g. counterclockwise) to decrease the color spread. A user may, for example, slide a (virtual or physical) slider in a first direction (e.g. rightward) to increase the color spread, and slide the slider in a second direction (e.g. leftward) to decrease the color spread (see FIG. 3b).

The processor 106 may be configured to receive the second user input during a period of time, and the processor 106 may be configured to increase the color spread as a function of a duration of the second user input. The second (temporal) user input, may for example be provided by actuating a user input element for a period of time (e.g. by pressing and holding a (physical or virtual) button). The user input element may be the same user input element for receiving the first user input (e.g. the same button to select the one or more initial colors), or it may be a different user input element (e.g. a separate button). The user may for example actuate a user input element for a period of time (e.g. a few seconds) to increase the color spread, and thereby the color variation of the light emitted by the plurality of lighting units 112, 114. When the maximum color spread is reached, the processor 106 may then reduce the color spread if the user is still actuating the user input element. Optionally, during the user input element actuation direct feedback may be given on the selected color spread and/or on the colors selected for the associated lighting units.

The processor 106 may be further configured to obtain information indicative of one or more of: an activity of a user, a mood of a user and an active atmosphere, and the processor 106 may be further configured to determine the color spread further based on the activity and/or the mood of the user. The information indicative of the activity and/or the mood of the user may be accessed by accessing a memory storing a current activity and/or mood of the user. The current activity and/or mood of the user may be defined (e.g. inputted) by the user. Alternatively, the activity and/or the mood may be detected using one or more sensors (e.g. audio sensors, cameras, sensors for detecting physiological parameters, etc.). Techniques for activity and/or mood detection are known in the art and will not be discussed in detail. The atmosphere may for example have been selected by a user, or it may have been activated based on another input (e.g. based on an actuation a sensor, a lighting control routine, etc.).

The processor 106 may be further configured to receive a third user input (e.g. via the user interface, or via a further user interface), and store the light scene (i.e. the light settings) of the plurality of lighting units 112, 114 in a memory after the second user input has been provided. The light settings may be stored for later retrieval, enabling a user to store and recall a created light scene.

The processor 106 may be further configured to control the plurality of lighting units 112, 114 based on the plurality of colors such that the light output of the plurality of lighting units 112, 114 changes over time. The processor 106 may, for example, control the lighting units such that they cycle through different colors of the color spread.

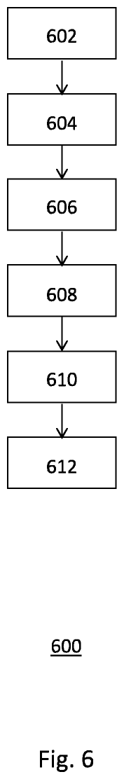

FIG. 6 shows schematically steps of a method 600 of controlling a plurality of lighting units 112, 114, the method 600 comprising:
receiving 602 a first user input indicative of a selection of one or more colors for the plurality of lighting units 112, 114,
controlling 604 the plurality of lighting units 112, 114 according to the selected one or more colors,
receiving 606 a second user input indicative of a selection of a value within a range of values,
obtaining 608 a color palette associated with the selected one or more colors,
determining 610 a color spread of colors of the color palette as a function of the value within the range of values, and
controlling 612 the plurality of lighting units 112, 114 via the communication unit according to a plurality of colors of the color spread.

The method 600 may be executed by computer program code of a computer program product when the computer program product is run on a processing unit of a computing device, such as the processor 106 of the control system 100.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A control system for controlling a plurality of lighting units, the control system comprising:
a communication unit configured to communicate with the plurality of lighting units,
a user interface configured to receive a first user input indicative of a selection of one or more colors for the plurality of lighting units,
a processor configured to control the plurality of lighting units via the communication unit according to the selected one or more colors,
wherein the user interface is configured to receive a second user input indicative of a selection of a value within a range of values, and
wherein the processor is configured to obtain a color palette associated with the selected one or more colors, to determine a color spread of colors of the color palette as a function of the value within the range of values, and to control the plurality of lighting units via the communication unit according to a plurality of colors of the color spread.

2. The control system of claim 1, wherein the processor is further configured to obtain location information of the plurality of lighting units indicative of locations of the plurality of lighting units relative to each other and/or to a user location, and wherein the processor is further configured to map the plurality of colors onto the plurality of lighting units based on the relative locations of the plurality of lighting units.

3. The control system of claim 1, wherein the processor is further configured to obtain information indicative of light rendering capabilities of the plurality of lighting units and/or indicative of types of the plurality of lighting units, and wherein the processor is further configured to map the plurality of colors onto the plurality of lighting units based on the light rendering capabilities and/or the types of the plurality of lighting units.

4. The control system of claim 1, wherein the user interface comprises a first user input element for receiving the first user input, and wherein the user interface comprises a second user input element for receiving the second user input.

5. The control system of claim 4, wherein the second user input element is a rotary element of a rotary switch, and wherein the second user input is a rotary movement of the rotary element.

6. The control system of claim 4, wherein the first user input element is a button.

7. The control system of claim 1, wherein the second user input is a directional user input, and wherein the processor is configured to increase the color spread when the second user input is provided in a first direction, and wherein the processor is configured to decrease the color spread when the second user input is provided in a second direction.

8. The control system of claim 1, wherein the second user input is received during a period of time, and wherein the processor is configured to increase the color spread as a function of a duration of the second user input.

9. The control system of claim 1, wherein the processor is configured to select colors from the plurality of colors of the color spread such that a difference between a first color and a second color is maximized.

10. The control system of claim 1, wherein the first user input is indicative of a selection of an image comprising the one or more colors for the plurality of lighting units, and wherein the processor is configured to obtain the color palette based on colors of the image.

11. The control system of claim 1, wherein the processor is further configured to obtain information indicative of one or more of:
an activity of a user, a mood of a user and an active atmosphere,
and wherein the processor is further configured to determine the color spread further based on the activity and/or the mood of the user.

12. The control system of claim 1, wherein the processor is further configured to determine the color spread based on a color matching rule, wherein the plurality of colors of the color spread match the one or more colors according to the color matching rule.

13. The control system of claim 1, wherein the communication unit, the user interface and the processor are comprised in a lighting control device.

14. A method of controlling a plurality of lighting units, the method comprising:
receiving a first user input indicative of a selection of one or more colors for the plurality of lighting units,
controlling the plurality of lighting units according to the selected one or more colors,
receiving a second user input indicative of a selection of a value within a range of values,
obtaining a color palette associated with the selected one or more colors,
determining a color spread of colors of the color palette as a function of the value within the range of values, and
controlling the plurality of lighting units via the communication unit according to a plurality of colors of the color spread.

15. A non-transitory computer program product for a computing device, the computer program product comprising computer program code to perform the method of claim 14 when the computer program product is run on a processing unit of the computing device.
